(19) United States
(12) Patent Application Publication
(10) Pub. No.: US 2026/0118164 A1
(43) Pub. Date: Apr. 30, 2026

(54) OPTICAL MODULE

(71) Applicant: Asahi Kasei Microdevices Corporation, Tokyo (JP)

(72) Inventors: Kenta FURUTA, Tokyo (JP); Kengo SASAYAMA, Tokyo (JP)

(73) Assignee: Asahi Kasei Microdevices Corporation, Tokyo (JP)

(21) Appl. No.: 19/370,772

(22) Filed: Oct. 28, 2025

(30) Foreign Application Priority Data
Oct. 31, 2024 (JP) 2024-192332
Sep. 24, 2025 (JP) 2025-158456

(51) Int. Cl. G01J 1/04; G01J 1/44; G02B 5/20; G02B 5/26

(52) U.S. Cl. CPC G01J 1/0492; G01J 1/44; G02B 5/208; G02B 5/26; G01J 2001/446

(57) ABSTRACT

The optical module includes a plurality of optical filters and an infrared receiving element. The plurality of optical filters is disposed in an optical path formed by infrared light emitted from a light source and has a common transmission wavelength range within a wavelength range to which the infrared light-receiving element has sensitivity. The maximum transmittance in the common transmission wavelength range is 20% or more of the maximum transmittance of each of a first optical filter and a second optical filter and is smaller than the respective maximum transmittances, and the FWHM of the first optical filter is smaller than the FWHM of the second optical filter.

### CROSS-REFERENCE TO RELATED APPLICATION

The present application claims priority to Japanese Patent Application No. 2024-192332 filed on Oct. 31, 2024, and Japanese Patent Application No. 2025-158456 filed on Sep. 24, 2025, the entire contents of which are incorporated herein by reference.

### TECHNICAL FIELD

The present disclosure relates to an optical module.

### BACKGROUND

Non-dispersive infrared (NDIR) absorption gas concentration measuring devices are known as conventional gas concentration measuring devices that measure concentration of a gas to be measured in the atmosphere. Different kinds of gas absorb infrared light at different wavelengths, and a non-dispersive infrared absorption gas concentration measuring device utilizes this principle and measures gas concentration by detecting the amount of absorption. For example, a non-dispersive infrared absorption gas concentration measuring device comprises an infrared optical element and an optical filter that transmits infrared light of a specific wavelength according to the gas to be measured. For example, Patent Literature (PTL) 1 discloses a gas sensor that includes a plurality of optical filters.

### CITATION LIST

### Patent Literature

PTL 1: U.S. Pat. No. 11,499,914 B2 Specification

### SUMMARY

Here, if the optical filter used in the gas sensor has a characteristic such that the slope on the cut-off side or cut-on side is gentle, the gas sensor may be more susceptible to the influence of gases that are not the target of detection (interfering gases), which may reduce the accuracy of measuring the gas concentration. Therefore, demand exists for high-performance optical filters with steep slopes.

It would be helpful to provide an optical module that includes a high-performance optical filter. Here, the optical module includes an infrared optical element and an optical filter, and is a module used in devices such as concentration measurement devices, infrared radiation thermometers (non-contact thermometers), infrared spectroscopic imaging, and human detection sensors. The optical module is an optical component in which an infrared optical element and an optical filter are arranged and packaged, for example, while maintaining the positional relationship between them so as to obtain desired characteristics.

(1) An optical module according to an embodiment of the present disclosure includes
a plurality of optical filters and an infrared light-receiving element, wherein
the plurality of optical filters is disposed in an optical path formed by infrared light emitted from a light source,
the plurality of optical filters includes at least a first optical filter disposed in the optical path so as to reflect infrared light and a second optical filter disposed in the optical path so as to transmit infrared light,
the first optical filter and the second optical filter have a common transmission wavelength range within a wavelength range to which the infrared light-receiving element has sensitivity,
a maximum transmittance in the common transmission wavelength range is 20% or more of a maximum transmittance of each of the first optical filter and the second optical filter and is smaller than the maximum transmittance of each of the first optical filter and the second optical filter, and
a FWHM of the first optical filter is smaller than a FWHM of the second optical filter.

(2) As an embodiment of the present disclosure, in (1),
a wavelength corresponding to the maximum transmittance in the common transmission wavelength range is located on a cut-on side of the first optical filter and on a cut-off side of the second optical filter.

(3) As an embodiment of the present disclosure, in (1) or (2),
the maximum transmittance in the common transmission wavelength range is 90% or less.

(4) As an embodiment of the present disclosure, in any one of (1) to (3),
the second optical filter has a transmission wavelength range on a shorter wavelength side than the first optical filter, and
a wavelength corresponding to 20% transmittance on a cut-off side of the second optical filter is shorter than a wavelength corresponding to the maximum transmittance of the first optical filter.

(5) As an embodiment of the present disclosure, in any one of (1) to (4),
a wavelength corresponding to 20% transmittance on a cut-on side of the first optical filter is longer than a wavelength corresponding to the maximum transmittance of the second optical filter.

(6) As an embodiment of the present disclosure, in any one of (1) to (5),
a wavelength corresponding to 20% transmittance on a cut-off side of the second optical filter is longer than a wavelength corresponding to 20% transmittance on a cut-on side of the first optical filter.

(7) As an embodiment of the present disclosure, in any one of (1) to (6),
a transmission spectrum of infrared light reflected by the first optical filter and transmitted by the second optical filter has a larger slope on a cut-off side than a transmission spectrum of infrared light transmitted through the second optical filter alone.

(8) As an embodiment of the present disclosure, in any one of (1) to (7),
in an optical path formed by infrared light reflected by the first optical filter and transmitted by the second optical filter, a ratio of a slope on a cut-on side of the first optical filter to a slope on a cut-off side of the second optical filter is 0.7 or more.

(9) As an embodiment of the present disclosure, in any one of (1) to (8),
a wavelength corresponding to the maximum transmittance in the common transmission wavelength range is located on a cut-off side of the first optical filter and a cut-on side of the second optical filter, and a transmission spectrum of infrared light reflected by the first optical filter and transmitted by the second optical filter has a larger slope on the cut-on side than the transmission spectrum of infrared light transmitted by the second optical filter alone.

(10) As an embodiment of the present disclosure, in (9),
in an optical path formed by infrared light reflected by the first optical filter and transmitted by the second optical filter, a ratio of a slope on a cut-off side of the first optical filter to a slope on a cut-on side of the second optical filter is 0.7 or more.

(11) As an embodiment of the present disclosure, in any one of (1) to (10),
at least one of the plurality of optical filters has an area that is 1.4 times or more larger than an area of another optical filter.

(12) As an embodiment of the present disclosure, in any one of (1) to (11),
at least one of the plurality of optical filters is a bandpass filter having a transmission band with a maximum transmittance of 60% or more in a wavelength range of 2000 nm to 10000 nm.

(13) As an embodiment of the present disclosure, in any one of (1) to (12),
at least one of the plurality of optical filters is a reflective filter.

(14) As an embodiment of the present disclosure, in any one of (1) to (13),
the optical module is usable in a non-dispersive infrared gas sensor or a photoacoustic gas sensor.

(15) As an embodiment of the present disclosure, in any one of (1) to (14),
the infrared light-receiving element is an infrared photodiode.

(16) An optical module according to an embodiment of the present disclosure includes
a plurality of optical filters and an infrared light-receiving element, wherein
the plurality of optical filters is disposed in an optical path formed by infrared light emitted from a light source,
the plurality of optical filters include at least a first optical filter disposed in the optical path so as to transmit infrared light and a second optical filter disposed in the optical path so as to transmit infrared light, and
the first optical filter is a band-stop filter and includes a transmission wavelength range of the second optical filter within a stopband, and a transmission spectrum of infrared light transmitted by the first optical filter and transmitted by the second optical filter has a larger slope on a cut-on side or a cut-off side than the transmission spectrum of infrared light transmitted by the second optical filter alone.

(17) As an embodiment of the present disclosure, in any one of (1) to (16), a cut-on side refers to a shorter wavelength side than a wavelength corresponding to a maximum transmittance, and a slope on the cut-on side is calculated by dividing “0.9-0.1” by a “size of a width of change in wavelength from 10% transmittance to 90% transmittance” when the maximum transmittance is normalized to 1.

(18) As an embodiment of the present disclosure, in any one of (1) to (16), a cut-on side refers to a shorter wavelength side than a wavelength corresponding to a maximum transmittance, and a slope on the cut-on side is calculated by dividing “0.8-0.1” by a “size of a width of change in wavelength from 10% transmittance to 80% transmittance” when the maximum transmittance is normalized to 1.

(19) As an embodiment of the present disclosure, in any one of (1) to (16), a cut-off side refers to a longer wavelength side than a wavelength corresponding to a maximum transmittance, and a slope on the cut-off side is calculated by dividing “0.9-0.1” by a “size of a width of change in wavelength from 90% transmittance to 10% transmittance” when the maximum transmittance is normalized to 1.

(20) As an embodiment of the present disclosure, in any one of (1) to (16), a cut-off side refers to a longer wavelength side than a wavelength corresponding to a maximum transmittance, and a slope on the cut-off side is calculated by dividing “0.8-0.1” by a “size of a width of change in wavelength from 80% transmittance to 10% transmittance” when the maximum transmittance is normalized to 1.

According to the present disclosure, an optical module including a high-performance optical filter can be provided.

### BRIEF DESCRIPTION OF THE DRAWINGS

In the accompanying drawings:

FIG. 1 is a diagram illustrating an example of a cross-section of an optical filter;

FIG. 2 is a diagram illustrating an example of a concentration measurement device including an optical module according to an embodiment of the present disclosure;

FIG. 3 is a diagram illustrating a configuration of an optical filter and an infrared optical element in the optical module;

FIG. 4 is a diagram illustrating examples of effective transmission characteristics obtained by combinations of optical filters in sets;

FIG. 5 is a diagram illustrating an example of the change in the effective slope magnitude when a set of optical filters is formed by combining single filters having different slopes;

FIG. 6 is a diagram illustrating an example of a stack structure of an infrared optical element;

FIG. 7 is a diagram illustrating transmission characteristics when the transmission wavelength range of a first optical filter is on the shorter wavelength side than the transmission wavelength range of a second optical filter;

FIG. 8 is a diagram illustrating how the slope becomes steeper as the FWHM (Full Width at Half Maximum) of an optical filter becomes narrower;

FIG. 9 is a diagram illustrating transmission characteristics when both the first and second optical filters are transmissive and the first optical filter is used as a band-stop filter; and

FIG. 10 is a diagram illustrating a configuration in which both the first and second optical filters are transmissive.

### DETAILED DESCRIPTION

Hereinafter, the optical module according to an embodiment of the present disclosure will be described with reference to the drawings.

### (Optical Module)

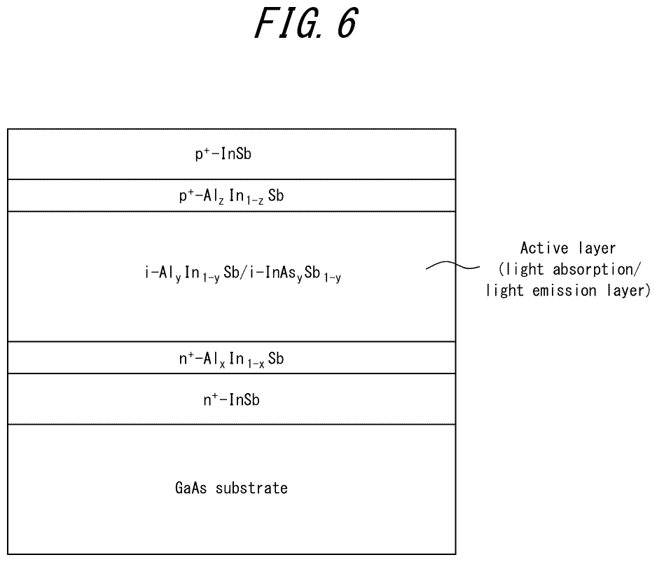

The optical module according to the present embodiment includes a plurality of optical filters and an infrared optical element. In the present embodiment, each of the plurality of optical filters has a configuration that includes a substrate and a multilayer film formed on at least one surface of the substrate, the multilayer film including a plurality of layers having different refractive indices. However, it suffices for at least one of the plurality of optical filters to be configured to include a substrate and a multilayer film. An infrared optical element is an infrared light-receiving element or an infrared light-emitting element, and is a collective name applied to either element. Furthermore, hereinafter, receive/emit light means having at least one of the functions of light-receiving or light-emitting. The infrared optical element is configured to include, for example, a first conductivity type semiconductor layer, an active layer, and a second conductivity type semiconductor layer, and receives/emits infrared light. That is, the optical module according to the present embodiment is an infrared module. For example, an infrared light-emitting element can be realized with the structure illustrated in FIG. 6, and an infrared light-receiving element can also be realized with the same structure. Specifically, the infrared light-emitting element is preferably a light emitting diode (LED). As another example, the infrared light-emitting element may be a lamp, a laser (Light Amplification by Stimulated Emission of Radiation), an organic light-emitting element, a MEMS (Micro Electro Mechanical Systems) heater, or the like. The infrared light-receiving element is preferably a photodiode (PD) in particular. As another example, the infrared light-receiving element may be a phototransistor, a thermopile, a pyroelectric sensor, a bolometer, or a photoacoustic detector.

The following description assumes that the optical device according to the present embodiment is used in a concentration measuring device. As described above, the optical module is an optical component in which an infrared optical element and an optical filter are arranged and packaged, for example, while maintaining the positional relationship between them so as to obtain desired characteristics. Furthermore, the optical module is not limited to concentration measurement devices and may be used in infrared radiation thermometers and the like.

In the present embodiment, the concentration measurement device is a gas sensor that measures the concentration of a gas to be measured. The concentration measuring device may be, for example, a non-dispersive infrared (NDIR) absorption gas sensor including a light-receiver that receives infrared light transmitted through gas. Furthermore, the concentration measuring device may be, for example, a photoacoustic gas sensor that measures gas concentration by using a high-performance microphone to pick up, as sound, the vibration of gas molecules that have absorbed light. That is, the optical module may be used in an NDIR gas sensor or a photoacoustic gas sensor.

Although details will be described later, the plurality of optical filters is disposed in an optical path formed by infrared light emitted from a light source (infrared light-emitting element). The plurality of optical filters include at least a first optical filter disposed in the optical path so as to reflect infrared light and a second optical filter disposed in the optical path so as to transmit infrared light. Furthermore, the first optical filter and the second optical filter have a common transmission wavelength range within a wavelength range to which the infrared light-receiving element has sensitivity. The maximum transmittance in the common transmission wavelength range is 20% or more of a maximum transmittance of each of the first optical filter and the second optical filter and is smaller than the maximum transmittance of each of the first optical filter and the second optical filter. The FWHM (Full Width at Half Maximum) of the first optical filter is smaller than the FWHM of the second optical filter. In another embodiment, both the first and second optical filters can be used as transmissive filters. In this case, the first optical filter can be a band-stop filter.

According to the optical module of the present embodiment, by combining a plurality of optical filters, the slope of the overall transmission spectrum resulting from the combination can be made larger than the slope of the transmission spectrum of a single optical filter. Here, “increasing” the slope means “making it sharper” or “making it steeper”. When the optical module is used in a gas sensor, for example, a gentle slope may make the gas sensor susceptible to the influence of interfering gases, which may reduce the accuracy of measuring the gas concentration. The optical module according to the present embodiment is used in, for example, a gas sensor and has a high-performance optical filter that does not reduce the measurement accuracy of gas concentration.

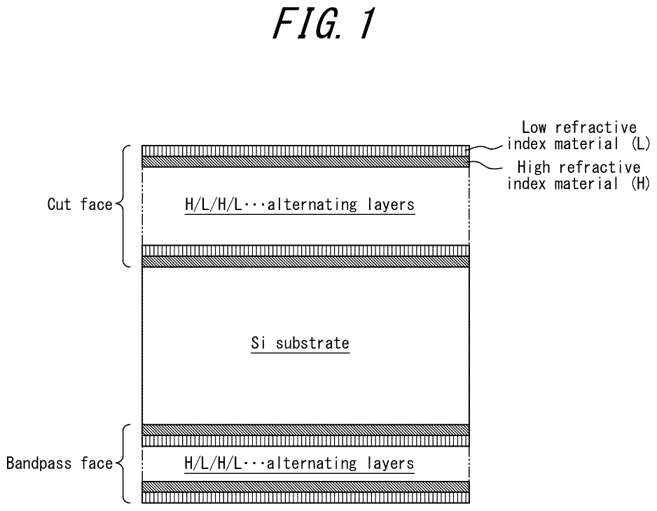

FIG. 1 illustrates an example of a cross-section of an optical filter. In the present embodiment, the optical filter has alternating layers made of a low refractive index material (L) and layers made of a high refractive index material (H) on both sides of a Si substrate. The layer made of the low refractive index material (L) is made of silicon monoxide (SiO), silicon dioxide (SiO₂), titanium dioxide (TiO₂), zinc sulfide (ZnS), aluminum oxide (Al₂O₃), or the like. The layer made of a high refractive index material (H) is made of Si, Ge, or the like. As the low refractive index material (L), a material having a refractive index from 1.2 to 2.5 is preferably selected. As the high refractive index material (H), a material having a refractive index that is at least 0.5 more than that of the low refractive index material (L) is preferably selected. The multilayer films of alternating layers are each formed so that the layer directly on the Si substrate is the high refractive index material (H). However, the optical filter is not limited to the configuration illustrated in FIG. 1. For example, the high refractive index material (H) need not be directly on the substrate.

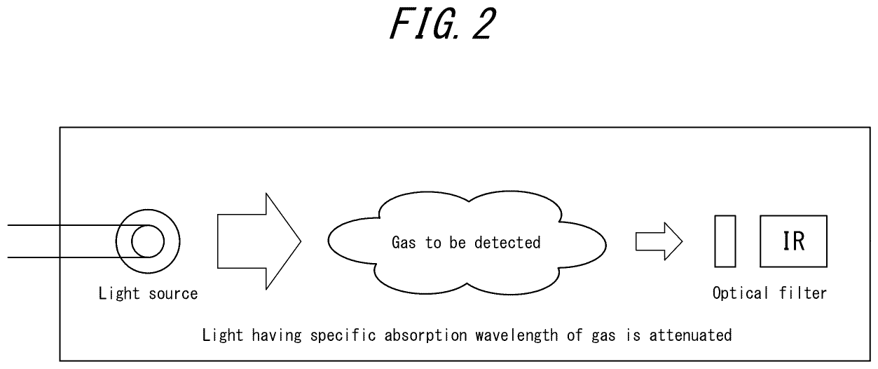

FIG. 2 is a diagram illustrating an example of a concentration measuring device using the optical module according to the present embodiment. In the optical module according to the present embodiment, an infrared light-receiving element (IR) is disposed in the optical path formed by the infrared light emitted from the infrared light-emitting element (light source), and a plurality of optical filters that selectively transmit the absorption wavelengths of the gas to be detected is disposed in front of the infrared receiving element. That is, a plurality of optical filters is disposed in the optical path formed by the infrared light emitted from the infrared light-emitting element (light source).

Here, the gas to be measured by the concentration measurement device is, for example, carbon dioxide (CO₂), but this example is not limiting. For example, the gas to be measured may be water vapor, carbon monoxide, nitrogen monoxide, ammonia, sulfur dioxide, alcohol, formaldehyde, methane, propane, or the like.

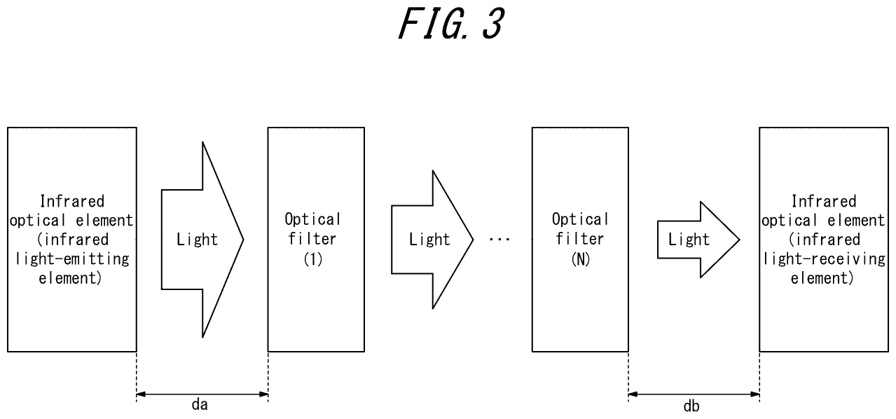

FIG. 3 is a diagram illustrating the configuration of the optical filter and an infrared optical element in the optical module. The optical filters are arranged in the optical path downstream from the infrared optical element that is a light-emitting element. The optical filters are also arranged in the optical path upstream from the infrared optical element that is a light-receiving element. The optical filters are arranged with a gap between them. Here, da is the distance between the infrared light-emitting element and the nearest optical filter. In addition, db is the distance between the infrared light-receiving element and the nearest optical filter. Each of da and db may be set to zero or greater. In addition, the optical module is not limited to the configuration illustrated in FIG. 3 and may, for example, have a configuration in which other optical members such as lenses or mirrors are further arranged in the optical path.

Below, the details of the components of the optical module according to the present embodiment will be described. Here, the optical module includes at least one of the infrared light-receiving element and the infrared light-emitting element, and the light-receiving sensitivity of the infrared light-receiving element and the light-emitting intensity of the infrared light-emitting element are described as “sensitivity”. That is, sensitivity can be interpreted as light-receiving sensitivity if the optical module is configured to include an infrared light-receiving element, and as light-emitting intensity if the optical module is configured to include an infrared light-emitting element.

### (Optical Filter)

The optical filter includes, as described above, a substrate and a multilayer film formed on the substrate, the multilayer film including a plurality of layers having different refractive indices. The multilayer film may be formed only on one side of the substrate or may be formed on both sides. The optical filter is disposed in the optical path where infrared light emitted from the infrared light-emitting element reaches the infrared light-receiving element in the concentration measurement device. The optical filter can be made by forming a first layer and a second layer on the substrate by vapor deposition.

A set of optical filters among the plurality of optical filters has a common transmission wavelength range within the wavelength range to which the infrared optical element is sensitive. That is, the transmission wavelength ranges of a pair of optical filters overlap, and the overlapping portion (common transmission wavelength range) is within the wavelength range to which the infrared optical element has sensitivity. The maximum transmittance in the common transmission wavelength range is 20% or more and is smaller than the maximum transmittance of each of the optical filters in the set. When one of a pair of optical filters is used for reflection and the other for transmission, the FWHM of the optical filter used for reflection is preferably smaller. When using a pair of optical filters that are both transmissive, one of the filters is preferably a band-stop filter.

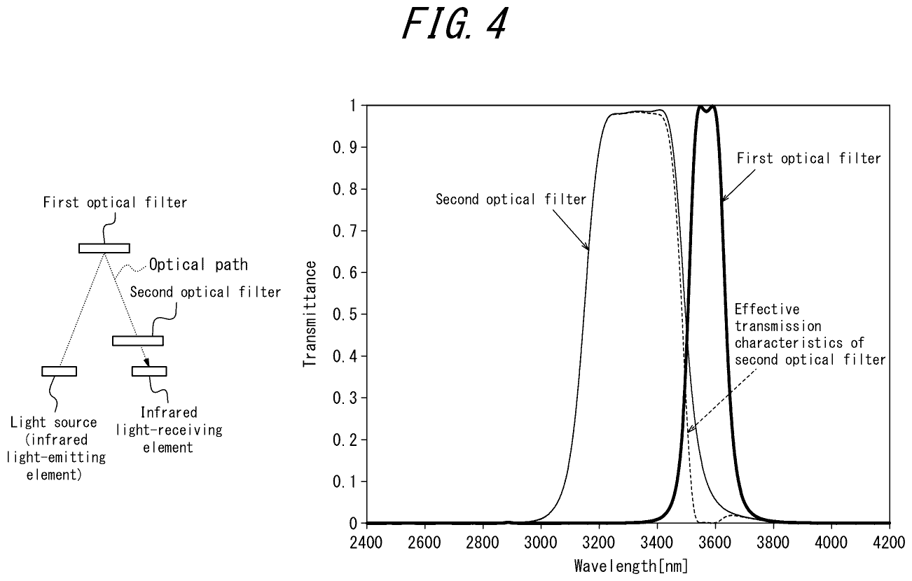

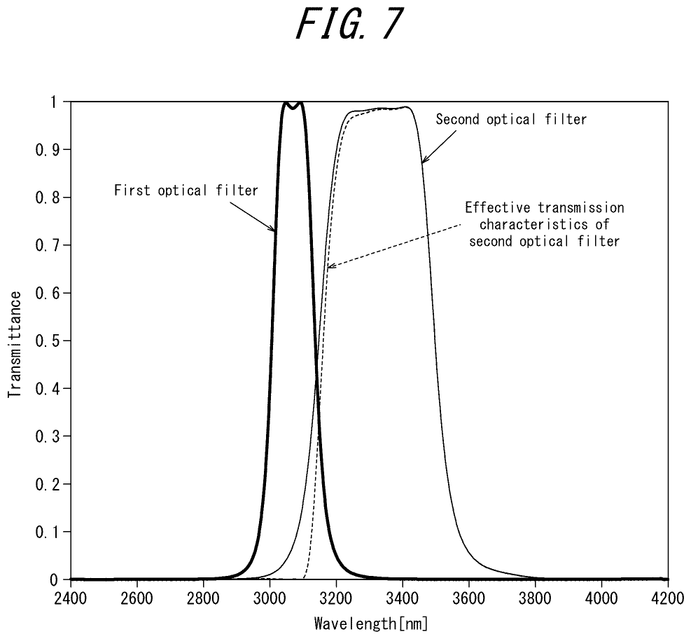

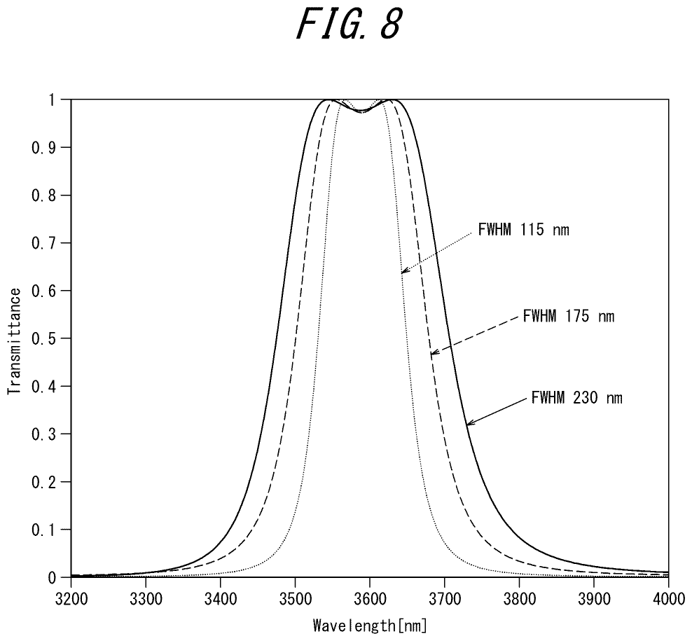

Here, FIG. 4 illustrates an example of effective transmission characteristics obtained by combinations of optical filters in sets. A set of optical filters is described here as being formed by a first optical filter and a second optical filter having a transmission wavelength range on the shorter wavelength side than the first optical filter. As illustrated in the left diagram of FIG. 4, a set of optical filters is disposed in the optical path along which infrared light emitted from a light source (infrared light-emitting element) enters the infrared light-receiving element. In the example of FIG. 4, the first optical filter is a reflective filter, and the second optical filter is a transmissive filter. However, the types of the plurality of optical filters including the set of optical filters are not limited, and for example, at least one of the plurality of optical filters may be a reflective filter. The configuration illustrated in FIG. 7, with a first optical filter and a second optical filter having a transmission wavelength range on the longer wavelength side than the first optical filter, may also be adopted. As illustrated in FIGS. 4 and 7, the FWHM of the first optical filter is preferably smaller than the FWHM of the second optical filter. This is because, as illustrated in FIG. 8, when the FWHM of the optical filter becomes narrower, the slope tends to become steeper. By making the first optical filter steep, the effective transmission characteristics of the second optical filter can be made steep.

In general, the size of the reflecting surface of a reflective filter is larger than the size of the light-receiving surface of a transmissive filter. The size of the plurality of optical filters is not limited to a particular size or range, but at least one of the optical filters (for example, a reflective filter) may have an area that is 1.4 times or more larger than the area of another optical filter (for example, a transmissive filter). Furthermore, the plurality of optical filters do not need to be composed of filters of a specific type and may be composed of, for example, a combination of bandpass filters, short-pass filters, long-pass filters, and the like. As one configuration example, at least one of the plurality of optical filters may be a bandpass filter having a transmission band with a maximum transmittance of 60% or more in a wavelength range of 2000 nm to 10000 nm.

Referring again to FIG. 4, the effective transmission characteristics obtained by a combination of optical filters in a set will be described. The right diagram in FIG. 4 illustrates the transmission characteristics of the first optical filter alone, the transmission characteristics of the second optical filter alone, and the effective transmission characteristics of the second optical filter in combination. The vertical axis represents transmittance. On the vertical axis, 1 corresponds to 100% transmittance, 0.6 corresponds to 60% transmittance, and 0.2 corresponds to 20% transmittance. The horizontal axis represents the wavelength of light (infrared light). FIG. 7 can be viewed in the same way as FIG. 4.

Regarding the transmission characteristics of an optical filter, the slope on the cut-on side and the slope on the cut-off side are defined as follows. First, the cut-on side refers to the shorter wavelength side than the wavelength corresponding to the maximum transmittance. The cut-off side refers to the longer wavelength side than the wavelength corresponding to the maximum transmittance. The slope on the cut-on side is calculated by dividing “0.9-0.1” by the “size of the bandwidth (width of change in wavelength) from 10% transmittance to 90% transmittance” when the maximum transmittance is normalized to 1. As another definition, the slope on the cut-on side may be calculated by dividing “0.8-0.1” by the “size of the bandwidth (width of change in wavelength) from 10% transmittance to 80% transmittance” when the maximum transmittance is normalized to 1. The slope on the cut-off side is calculated by dividing “0.9-0.1” by the “size of the bandwidth (width of change in wavelength) from 90% transmittance to 10% transmittance” when the maximum transmittance is normalized to 1. As another definition, the slope on the cut-off side may be calculated by dividing “0.8-0.1” by the “size of the bandwidth (width of change in wavelength) from 80% transmittance to 10% transmittance” when the maximum transmittance is normalized to 1. The larger the slope value, the steeper the change in transmittance (transmission characteristics) of the optical filter. Conversely, the smaller the slope value, the more gradual the change in transmittance of the optical filter. In the present embodiment, since the unit of the bandwidth (width of change in wavelength) is nm, the unit of the slope is “%/nm”. Here, when the shape of the peak is irregular, the transmittance at the center of the FWHM may be normalized to 1, and the above calculation formula may be applied.

In the example of FIG. 4, the slope on the cut-on side of the first optical filter alone was 1.40%/nm, and the slope on the cut-off side was 1.17%/nm. The slopes on the cut-on side and the cut-off side of the second optical filter alone were gentler than the transmission characteristics of the first optical filter alone, being 0.70%/nm on the cut-on side and 0.67%/nm on the cut-off side. In contrast, the effective transmission characteristics of the second optical filter obtained by the combination were such that the slope on the cut-off side was 1.27%/nm. Here, the slope on the cut-on side of the second optical filter, which has no overlapping transmission wavelength band, remains at 0.70%/nm. In the example of FIG. 7, the slope on the cut-on side of the second optical filter is increased due to the effect of the first optical filter.

In the examples of FIGS. 4 and 7, the set of optical filters has a common transmission wavelength range within the wavelength range to which the infrared optical element is sensitive. The maximum transmittance in the common transmission wavelength range is 20% or more (approximately 70%) and is smaller than the maximum transmittance of each of the optical filters in the set (each 100%). That is, the “mountains” of the transmission characteristics of a pair of optical filters do not completely overlap, but rather a common transmission wavelength range exists between the peaks (points illustrating maximum transmittance) of the respective “mountains”. In this case, the effective transmission characteristic (slope on the cut-off side) of the second optical filter due to the combination can be made steeper than the slope of each individual filter. The optical module according to the present embodiment utilizes the property that the effective slope can be made steep by the combination of a set of optical filters, thereby realizing an optical module equipped with a high-performance optical filter.

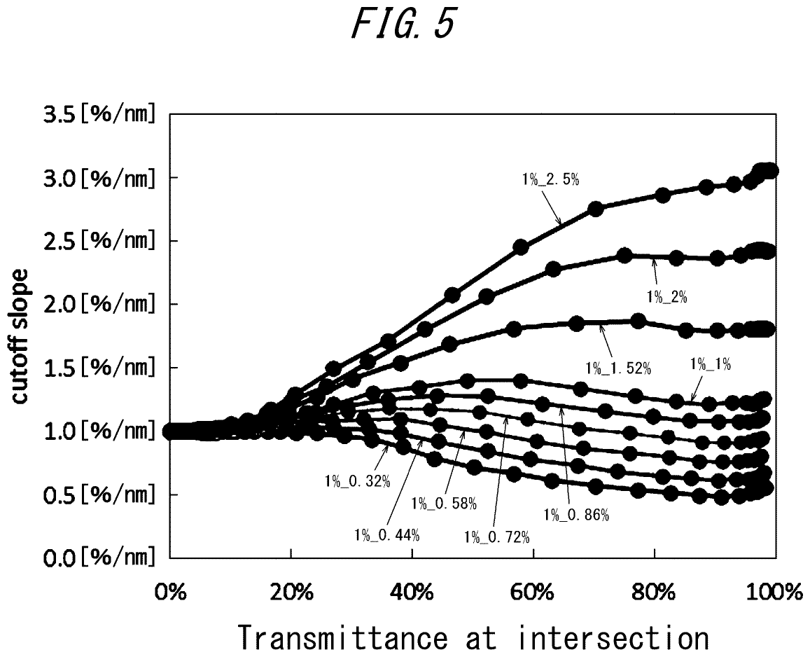

FIG. 5 illustrates an example of the change in the effective slope magnitude when a set of optical filters is formed by combining single filters having different slopes. The vertical axis represents the value of the effective cut-off side slope of the second optical filter. The horizontal axis represents the maximum transmittance (transmittance at the intersection) in the common transmission wavelength range. Each characteristic curve is represented by “(slope on the cut-off side of the second optical filter)_(slope on the cut-on side of the first optical filter)”. In the example of FIG. 5, the slope on the cut-off side of the second optical filter is fixed at 1%/nm. Here, a similar trend was confirmed when the vertical axis was changed to the slope on the cut-on side of the first optical filter, the slope on the cut-on side of the first optical filter was fixed, and the slope on the cut-off side of the second optical filter was varied. As illustrated in FIG. 5, when the maximum transmittance (transmittance at the intersection) in the common transmission wavelength range is 20% or more, the effective slope can be made larger (steeper) than the slope on the cut-off side of the second optical filter alone. However, it was confirmed that if the slope on the cut-on side of the first optical filter is made extremely gentle, the effective slope does not increase. The maximum transmittance in the common transmission wavelength range may be 90% or less. As illustrated in FIG. 5, even if the value is increased beyond 90%, no significant increase is observed.

With regard to the overlap of the set of optical filters, a wavelength corresponding to 20% transmittance on a cut-off side of the second optical filter may be shorter than a wavelength corresponding to the maximum transmittance of the first optical filter. The wavelength corresponding to 20% transmittance on the cut-on side of the first optical filter may be longer than the wavelength corresponding to the maximum transmittance of the second optical filter (see FIG. 4). The wavelength corresponding to 20% transmittance on the cut-off side of the second optical filter may be longer than the wavelength corresponding to 20% transmittance on a cut-on side of the first optical filter (see FIG. 4).

The transmission spectrum of infrared light reflected by the first optical filter and transmitted by the second optical filter can be made to have a larger slope on the cut-off side than the transmission spectrum of infrared light transmitted through the second optical filter alone. In an optical path formed by infrared light reflected by the first optical filter and transmitted by the second optical filter, the ratio of the slope on the cut-on side of the first optical filter to the slope on the cut-off side of the second optical filter may be 0.7 or more. That is, the calculated value of “(slope on the cut-on side of the first optical filter)/(slope on the cut-off side of the second optical filter)” may be 0.7 or more. For example, in “1%_1.52%”, “1%_2%”, and “1%_2.5%” in FIG. 5, the above ratio conditions are satisfied, and the effective slope is larger (steeper) than in other combinations.

As described above, the effect of making the effective slope steeper becomes more pronounced as the slope of the first optical filter becomes steeper. Furthermore, as illustrated in FIG. 8, the slope of the optical filter tends to be steeper as the FWHM becomes smaller. Therefore, by making the FWHM of the first optical filter smaller than the FWHM of the second optical filter, the effect of making the effective slope steeper by the combination is enhanced.

The transmission wavelength range of the first optical filter may be configured to be on the shorter wavelength side than the transmission wavelength range of the second optical filter. In this case, the transmission spectrum of infrared light reflected by the first optical filter and transmitted by the second optical filter can be made to have a larger slope on the cut-on side than the transmission spectrum of infrared light transmitted through the second optical filter alone. In an optical path formed by infrared light reflected by the first optical filter and transmitted by the second optical filter, the ratio of the slope on the cut-off side of the first optical filter to the slope on the cut-on side of the second optical filter may be 0.7 or more. That is, the calculated value of “(slope on the cut-off side of the first optical filter)/(slope on the cut-on side of the second optical filter)” may be 0.7 or more.

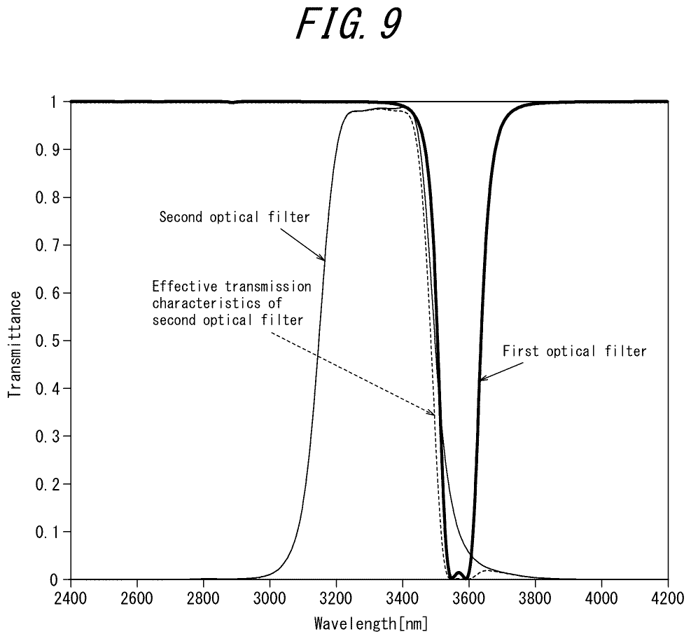

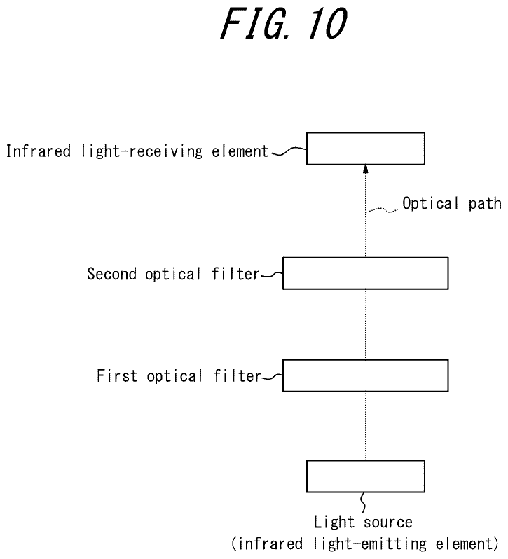

As illustrated in FIG. 10, the first optical filter and second optical filter may both be used as transmissive filters. In this case, by setting the first optical filter to be a band-stop filter, the effective transmission spectrum of the second optical filter can be made steeper. FIG. 9 illustrates the transmission characteristics when the first optical filter and the second optical filter are both used as transmissive filters and the first optical filter is used as a band-stop filter. It can be seen that the effective transmission spectrum on the cut-off side of the second optical filter becomes steeper. If the stopband of the first optical filter is designed to be on the shorter wavelength side of the second optical filter, it is possible to make the cut-on side steeper.

Here, the transmittance varies depending on the measurement conditions. Specifically, the transmittance varies depending on temperature and the angle of incidence of light. In the present embodiment, the temperature is assumed to be 25° C. Also, the angle of incidence of light can, for example, be 0°, 10°, 20°, 30°, 40°, 45°, or the like, depending on the design of the concentration measurement device, but it suffices for the above characteristics to be satisfied at any one angle of incidence. For example, it suffices for the optical filter to satisfy the above characteristics at least at one of the angles of incidence that can be set in the design (for example, 30°). Here, the optical filter more preferably satisfies the above characteristics at all angles of incidence that can be set in the design.

### (Substrate)

The substrate may be suitable for forming each layer constituting the multilayer film. Examples include silicon substrates, germanium substrates, sapphire substrates, or glass substrates, but the substrate is not limited to these examples.

### (Multilayer Film)

The multilayer film is a film having a plurality of layers with different refractive indices. In the present embodiment, the multilayer film includes a structure in which a first layer having a refractive index of 1.2 or more and 2.5 or less in the wavelength range of 6 μm to 10 μm and a second layer having a refractive index of 3.2 or more and 4.3 or less in the wavelength range of 6 μm to 10 μm are alternately stacked. The first layer is made of the aforementioned low refractive index material (L). The second layer is made of the aforementioned high refractive index material (H).

### (First Layer)

Specific materials for the first layer include titanium dioxide, zinc sulfide, silicon monoxide, and silicon dioxide.

### (Second Layer)

Specific materials for the second layer include silicon (Si) and germanium (Ge).

### (Method of Measuring Refractive Index)

The refractive indices of the first layer and the second layer can be measured using an ellipsometer in accordance with “JIS K7142”.

Here, the material and film thickness of each of the plurality of stacked first layers may be the same or different. Also, the material and film thickness of each of the plurality of stacked second layers may be the same or different. The multilayer film may further include layers different from the first layer and the second layer.

### (Infrared Optical Element)

The infrared optical element may be configured to have a first conductivity type semiconductor layer, an active layer, and a second conductivity type semiconductor layer. Specifically, the infrared optical element is an infrared light-emitting diode or an infrared photodiode.

The active layer is a light-absorbing layer or a light-emitting layer (see FIG. 6). In the present embodiment, the active layer is formed of Al_{y}In_{1-y}Sb (0≤y≤0.14) or InAs_{y}Sb_{1-y} (0≤y≤0.2). “Al_{y}In_{1-y}Sb (0≤y≤0.14)” means that Al, In, and Sb are contained within the layer, but this expression also includes cases in which other elements are present. Specifically, this expression also includes cases where slight changes are made to the composition of this layer by adding a small amount of other elements (for example, several percent or less of elements such as As, P, Ga, and N). This is similarly true for expressions of other compositions.

Here, the Al composition or As composition can be determined, for example, by secondary ion mass spectrometry (SIMS). For example, a magnetic field type SIMS device IMS 7f, manufactured by CAMECA, can be used for measurement.

The second conductivity type is a different conductivity type from the first conductivity type. The first conductivity type and the second conductivity type may each be any of n-type (including n-type impurities), i-type (without impurities), or p-type (including p-type impurities). The first conductivity type semiconductor layer may be composed of, for example, n-type InSb (see FIG. 6). The second conductivity type semiconductor layer may be composed of, for example, p-type InSb (see FIG. 6). In the present embodiment, the first conductivity type is n-type, and the second conductivity type is p-type.

The first conductivity type semiconductor layer, active layer, and second conductivity type semiconductor layer may be formed on a semiconductor substrate such as a gallium arsenide (GaAs) substrate or a silicon substrate. In the present embodiment, the first conductivity type semiconductor layer, active layer, and second conductivity type semiconductor layer are arranged in this order from the substrate in the infrared optical element. As another example, the second conductivity type semiconductor layer, active layer, and first conductivity type semiconductor layer may be arranged in this order from the substrate in the infrared optical element.

A barrier layer consisting of one or more layers may be provided between the first conductivity type semiconductor layer and the active layer. Also, a barrier layer consisting of one or more layers may be provided between the active layer and the second conductivity type semiconductor layer. In the present embodiment, an n-type barrier layer is provided between the first conductivity type semiconductor layer and the active layer, and a p-type barrier layer is provided between the active layer and the second conductivity type semiconductor layer. The n-type barrier layer is composed of, for example, n-type AlₓIn₁₋ₓSb (0.13≤x≤0.35) (see FIG. 6). The p-type barrier layer is composed of p-type Al_{z}In_{1-z}Sb (0.13≤z≤0.35) (see FIG. 6).

The infrared optical element preferably has a ratio of maximum sensitivity to minimum sensitivity of 20 or more in the wavelength range of 2000 nm to 10000 nm.

As described above, the optical module according to the present embodiment combines a plurality of optical filters to make the effective slope resulting from the combination larger (sharper, steeper) than the slope of the transmission spectrum of a single optical filter. Therefore, an optical module that includes a high-performance optical filter can be provided.

While embodiments of the present disclosure have been described with reference to the drawings and examples, it should be noted that various modifications and amendments may easily be implemented by those skilled in the art based on the present disclosure. Accordingly, such modifications and amendments are included within the scope of the present disclosure.

1. An optical module comprising:
a plurality of optical filters and an infrared light-receiving element, wherein
the plurality of optical filters is disposed in an optical path formed by infrared light emitted from a light source,
the plurality of optical filters includes at least a first optical filter disposed in the optical path so as to reflect infrared light and a second optical filter disposed in the optical path so as to transmit infrared light,
the first optical filter and the second optical filter have a common transmission wavelength range within a wavelength range to which the infrared light-receiving element has sensitivity,
a maximum transmittance in the common transmission wavelength range is 20% or more of a maximum transmittance of each of the first optical filter and the second optical filter and is smaller than the maximum transmittance of each of the first optical filter and the second optical filter, and
a FWHM of the first optical filter is smaller than a FWHM of the second optical filter.

2. The optical module according to claim 1, wherein a wavelength corresponding to the maximum transmittance in the common transmission wavelength range is located on a cut-on side of the first optical filter and on a cut-off side of the second optical filter.

3. The optical module according to claim 1, wherein the maximum transmittance in the common transmission wavelength range is 90% or less.

4. The optical module according to claim 1, wherein the second optical filter has a transmission wavelength range on a shorter wavelength side than the first optical filter, and
a wavelength corresponding to 20% transmittance on a cut-off side of the second optical filter is shorter than a wavelength corresponding to the maximum transmittance of the first optical filter.

5. The optical module according to claim 4, wherein a wavelength corresponding to 20% transmittance on a cut-on side of the first optical filter is longer than a wavelength corresponding to the maximum transmittance of the second optical filter.

6. The optical module according to claim 4, wherein a wavelength corresponding to 20% transmittance on the cut-off side of the second optical filter is longer than a wavelength corresponding to 20% transmittance on a cut-on side of the first optical filter.

7. The optical module according to claim 4, wherein a transmission spectrum of infrared light reflected by the first optical filter and transmitted by the second optical filter has a larger slope on a cut-off side than a transmission spectrum of infrared light transmitted through the second optical filter alone.

8. The optical module according to claim 7, wherein in an optical path formed by infrared light reflected by the first optical filter and transmitted by the second optical filter, a ratio of a slope on a cut-on side of the first optical filter to a slope on a cut-off side of the second optical filter is 0.7 or more.

9. The optical module according to claim 1, wherein a wavelength corresponding to the maximum transmittance in the common transmission wavelength range is located on a cut-off side of the first optical filter and a cut-on side of the second optical filter, and a transmission spectrum of infrared light reflected by the first optical filter and transmitted by the second optical filter has a larger slope on the cut-on side than the transmission spectrum of infrared light transmitted by the second optical filter alone.

10. The optical module according to claim 9, wherein in an optical path formed by infrared light reflected by the first optical filter and transmitted by the second optical filter, a ratio of a slope on a cut-off side of the first optical filter to a slope on a cut-on side of the second optical filter is 0.7 or more.

11. The optical module according to claim 1, wherein at least one of the plurality of optical filters has an area that is 1.4 times or more larger than an area of another optical filter.

12. The optical module according to claim 1, wherein at least one of the plurality of optical filters is a bandpass filter having a transmission band with a maximum transmittance of 60% or more in a wavelength range of 2000 nm to 10000 nm.

13. The optical module according to claim 1, wherein at least one of the plurality of optical filters is a reflective filter.

14. The optical module according to claim 1, wherein the optical module is usable in a non-dispersive infrared gas sensor or a photoacoustic gas sensor.

15. The optical module according to claim 1, wherein the infrared light-receiving element is an infrared photodiode.

16. An optical module comprising:
a plurality of optical filters and an infrared light-receiving element, wherein
the plurality of optical filters is disposed in an optical path formed by infrared light emitted from a light source,
the plurality of optical filters include at least a first optical filter disposed in the optical path so as to transmit infrared light and a second optical filter disposed in the optical path so as to transmit infrared light, and
the first optical filter is a band-stop filter and includes a transmission wavelength range of the second optical filter within a stopband, and a transmission spectrum of infrared light transmitted by the first optical filter and transmitted by the second optical filter has a larger slope on a cut-on side or a cut-off side than the transmission spectrum of infrared light transmitted by the second optical filter alone.

17. The optical module according to claim 1, wherein a cut-on side refers to a shorter wavelength side than a wavelength corresponding to a maximum transmittance, and a slope on the cut-on side is calculated by dividing “0.9-0.1” by a “size of a width of change in wavelength from 10% transmittance to 90% transmittance” when the maximum transmittance is normalized to 1.

18. The optical module according to claim 1, wherein a cut-on side refers to a shorter wavelength side than a wavelength corresponding to a maximum transmittance, and a slope on the cut-on side is calculated by dividing “0.8-0.1” by a “size of a width of change in wavelength from 10% transmittance to 80% transmittance” when the maximum transmittance is normalized to 1.

19. The optical module according to claim 1, wherein a cut-off side refers to a longer wavelength side than a wavelength corresponding to a maximum transmittance, and a slope on the cut-off side is calculated by dividing “0.9-0.1” by a “size of a width of change in wavelength from 90% transmittance to 10% transmittance” when the maximum transmittance is normalized to 1.

20. The optical module according to claim 1, wherein a cut-off side refers to a longer wavelength side than a wavelength corresponding to a maximum transmittance, and a slope on the cut-off side is calculated by dividing “0.8-0.1” by a “size of a width of change in wavelength from 80% transmittance to 10% transmittance” when the maximum transmittance is normalized to 1.
